(19) United States
(12) Patent Application Publication
(10) Pub. No.: US 2006/0047042 A1
(43) Pub. Date: Mar. 2, 2006

(54) Composition of dusting agent for rubber sheet

(76) Inventors: Hee-Dae Park, Busan (KR); Metha Yagnick, Rahway, NJ (US)

Correspondence Address: ST. ONGE STEWARD JOHNSTON & REENS, LLC, 986 BEDFORD STREET, STAMFORD, CT, 06905-5619, US

(21) Appl. No.: 10/930,084

(22) Filed: Aug. 31, 2004

(51) Int. Cl. C08K 5/09

(52) U.S. Cl. 524/394

(57) ABSTRACT

Disclosed is a composition of a dusting agent for a rubber sheet, by which a mold is not contaminated during press operations. The composition consists of polyether polyol, stearate, alcohol, and defoamer. The composition prevents a surface of a mold coated with noxious substance, such as chrome or Teflon, or a non-plating mold from being contaminated at press operations. Also, the composition easily carries out a dusting treatment by simply dipping a rubber sheet into a solution of dusting agent.

### BACKGROUND OF THE INVENTION

1. Field of the Invention

The present invention relates to a composition of a dusting agent, and more particularly, to a composition of a dusting agent for a rubber sheet, by which a mold is not contaminated during press operations.

2. Background of the Related Art

Generally, a sheet of rubber mixed in a rubber kneader is carried for use during a next process. At this time, the rubber sheet is applied with a dusting agent so that the rubber sheet is adhered to other sheet of the rubber.

Such a dusting agent is made from metallic stearate and emulsifier. If the rubber sheet applied with the dusting agent is input into a mold to carry out press operations, the mold coated with chrome or Teflon is contaminated by the dusting agent.

In addition, in the case of dipping the dusting agent, a concentration of the dusting agent should be adjusted by visually checking the adhering state of the sheets. Furthermore, a non-plating mold has some problems of reducing a slip of a surface and increasing an occurrence of the contamination due to the adherence of rubber, additives and dusting agent against the surface of the mold.

### SUMMARY OF THE INVENTION

Accordingly, the present invention is directed to a dusting agent that substantially obviates one or more problems due to limitations and disadvantages of the related art.

An object of the present invention is to provide a composition of a dusting agent for a rubber sheet, by which a mold is not contaminated during press operations.

Another object of the present invention is to provide a composition of a dusting agent capable of preventing rubber sheets from being adhered to each other, when soles of shoes are produced.

Still another object of the present invention is to provide a composition of a dusting agent capable of preventing a surface of a non-plating mold from being contaminated.

To achieve the object and other advantages, according to one aspect of the present invention, there is provided a composition of a dusting agent for a rubber sheet, the composition consisting of: polyether polyol, stearate, alcohol, and defoamer.

According to one embodiment, the composition may consist of polyether polyol, glycerin ether, defoamer, a mixture of magnesium stearate and stearic acid, ethyl alcohol, and water.

According to one embodiment, the composition may consist of polyether polyol, glycerin ether, defoamer, zinc stearate, ethyl alcohol, and water.

According to one embodiment, the composition consists of DC 65 additive, DC 2-3150, and water.

It is to be understood that both the foregoing general description and the following detailed description of the present invention are exemplary and explanatory and are intended to provide further explanation of the invention as claimed.

### DETAILED DESCRIPTION OF PREFERRED EMBODIMENTS

A preferred embodiment according to the present invention will now be explained. The below described embodiments of the present invention are intended to be illustrative only. Numerous alternative embodiments may be devised by those skilled in the art without departing from the scope of the following claims.

The present invention teaches a composition of a dusting agent for a rubber sheet, by which rubber sheets cannot be adhered to each other when the rubber sheet is layered on the other rubber sheet to carry out press operations. When the press operation is carried out by use of a mold coated with noxious substance such as chrome or Teflon or a non-plating mold, a dusting treatment is applied to the rubber sheet only by dipping the rubber sheet into a solution of a dusting agent according to the present invention. Consequently, the rubber sheet is not adhered to a surface of the mold, which prevents the contamination of the mold. In addition, an operator is not necessary to adjust a concentration of the dusting agent by visually checking the adhesion of the rubber sheet. The compositions of the dusting agents are described in detail in the below Table 1.

Composition ratios disclosed in Table 1 are the best mode to embody the present invention, and teachings of the present invention is to provide the composition of the dusting agent capable of being preventing the rubber sheets from being adhered to each other, so that the surface of the mold from is not contaminated.

TABLE 1

| Composition of dusting agent | | | Ratio |
|---|---|---|---|
| No. | Designation | Chemical | (wt. %) |
| 1 | PPG-2050 | polyether polyol | 10˜42 |
| | D | | (Mg St.Type, |
| | | | Zinc St. Type) |
| 2 | PPG-2021 | polyether polyol | 1˜15 |
| | | | (Mg St. Type, |
| | | | Zinc St. Type |
| 3 | KM-4040 | glycerin ether | 1˜7 |
| | | | (Mg St.Type, |
| | | | Zinc St. Type) |
| 4 | NSN | defoamer | 1˜6 |
| | | (non-silicone) | (Mg St. Type, |
| | | | Zinc St. Type) |
| 5 | Mg St | magnesium stearate, | 5.5˜13.5 |
| | | stearic acid | (Mg St. Type) |
| 6 | Zinc St | zinc stearate | 15˜35 |
| | | | (Zinc St. Type) |
| 7 | Water | | 10˜78 |
| | | | (Mg St. Type, |
| | | | Zinc St. Type, |
| | | | Silicone Type) |
| 8 | DC 65 | water, polydimethylsiloxane, | 12˜15 |
| | Additive | dimethyl siloxane, hydroxy- | (Silicone Type) |
| | | terminated, dimethyl, methyl | |
| | | siloxane, octylphonoxy poly- | |
| | | ethoxy ethanol,treated amorphous | |
| | | silica, polyether polyol, | |
| | | octamethylcyclotrasiloxane, | |
| | | polyethylene glycol stearyl | |
| | | ether, methyl hydrozypropyl, | |
| | | ethoxylated proproxylated | |
| | | siloxane, treated silica, | |
| | | decamethylcycolopentasiloxane | |
| 9 | DC | water, polypropylene glycol, | 16˜18 |
| | 2-3150 | propyleneoxide polymer with | (Silicone Type) |
| | | ethylene oxide, polydimethyl- | |
| | | sioxane, treated amorphous | |
| | | silica, dimethyl siloxane/silica | |
| | | reaction product, methyl siloxane | |
| 10 | Ethyl | | 0.1˜1.0 |
| | Alcohol | | (Mg St. Type, |
| | | | Zinc St. Type) |

Preferred embodiments of the present invention will now be described in detail, but the present invention is not restricted thereto. It will be noted that the compositions described in each embodiments is not represented by a chemical name, but represented by a trademark shown in Table 1.

### Embodiment 1

A dusting agent (Poly Dip JB 30-1; brand name) was produced by mixing PPG-2050D of 13 wt. %, PPG-5021 of 4 wt. %, KM-4040 of 3 wt. %, NSN of 2.5 wt. %,. and Mg St of 9.5 wt. %, 67.5 wt. % water, and ethyl alcohol of 0.5 wt. %.

### Embodiment 2

A dusting agent (Poly Dip Zn50; brand name) was produced by mixing PPG-2050D of 39 wt. %, PPG-5021 of 12 wt. %. KM-4040 of 4 wt. %, NSN of 4 wt. %, Zinc St of 25 wt. %, water of 15.5 wt. %, and ethyl alcohol of 0.5 wt. %.

### Embodiment 3

A dusting agent (Poly Dip 6531; brand name) was produced by mixing water of 67˜73 wt. %, 65 additive of 12˜15 wt. %, and DC 2-3150 of 15˜18 wt. %.

When the dusting agents made of the above compositions, which are Poly Dip JB 30-1, Poly Dip Zn50, and Poly Dip 6531, are used in a rubber sheet for producing a shoe sole (i.e., shoe outsole), it is possible to prevent the contamination of the surface of the mold, irrespective of a plated mold or non-plated mold.

The dusting agent of Poly Dip JB 30-1 was very suitable for a rubber sheet of magnesium stearate type, the dusting agent of Poly Dip Zn50 was very suitable for a rubber sheet of zinc stearate type, and the dusting agent of Poly Dip 6531 was very suitable for a rubber sheet of silicone type.

With the above description, the present invention can prevent a surface of a mold coated with noxious substance, such as chrome or Teflon, or a non-plating mold from being contaminated during press operations.

In addition, the present invention can easily carry out a dusting treatment by simply dipping a rubber sheet into a solution of dusting agent.

In particular, when a shoe outsole is manufactured, the present invention can prevent the contamination of the mold during the press operations.

The foregoing embodiments are merely exemplary and are not to be construed as limiting the present invention. The present teachings can be readily applied to other types of apparatus. The description of the present invention is intended to be illustrative, and not to limit the scope of the claims. Many alternatives, modifications, and variations will be apparent to those skilled in the art.

What is claimed is:

1. A composition of a dusting agent for a rubber sheet, the composition consisting of:
polyether polyol, stearate, alcohol, and defoamer.

2. The composition as claimed in claim 1, wherein the composition consists of polyether polyol, glycerin ether, defoamer, a mixture of magnesium stearate and stearic acid, ethyl alcohol, and water.

3. The composition as claimed in claim 1, wherein the composition consists of polyether polyol, glycerin ether, defoamer, zinc stearate, ethyl alcohol, and water.

4. The composition as claimed in claim 1, wherein the composition consists of DC 65 additive, DC 2-3150, and water.

5. The composition as claimed in claim 1, wherein the rubber sheet is a rubber for use in a shoe sole.
